(19) United States
(12) Patent Application Publication
(10) Pub. No.: US 2016/0078174 A1
(43) Pub. Date: Mar. 17, 2016

(54) ELECTRONIC MEDICAL RECORDS SYSTEM-BASED INQUIRY APPARATUS FOR EXAMINATION INFORMATION, AND METHOD FOR SUCH INQUIRY

(71) Applicant: SEOUL NATIONAL UNIVERESITY BUNDANG HOSPITAL, Gyeonggi-do (KR)

(72) Inventors: Chin Youb CHUNG, Gyeonggi-do (KR); Rong Min BAEK, Seoul (KR); Hee HWANG, Daejeon (KR); Kee Hyuck LEE, Gyeonggi-do (KR); Soo Young YOO, Gyeonggi-do (KR); Jong Hoar YOON, Gyeonggi-do (KR)

(21) Appl. No.: 14/787,188

(22) PCT Filed: Apr. 21, 2014
(86) PCT No.: PCT/KR2014/003459

§ 371 Date: Oct. 26, 2015

(30) Foreign Application Priority Data
Apr. 25, 2013 (KR) 10-2013-0045984

(51) Int. Cl. G06F 19/00

(52) U.S. Cl. CPC G06F 19/321; G06F 19/322

(57) ABSTRACT

The present invention relates to an electronic medical record system-based apparatus and method for inquiring about examination information, which can filter and inquire about a plurality of pieces of examination information, stored on a patient basis, in accordance with criteria set by a user, can vary information to be displayed in accordance with the size of a task window in which examination results are retrieved, and can compare a plurality of examination results.

### TECHNICAL FIELD

The present invention relates generally to technology for inquiring about examination information in an electronic medical record system, and more particularly to an electronic medical record system-based apparatus and method for inquiring about examination information, which can filter and inquire about a plurality of pieces of examination information, stored on a patient basis, in accordance with criteria set by a user, can rearrange information to be displayed in accordance with the size of a task window in which examination results are retrieved, and can compare a plurality of examination results.

### BACKGROUND ART

In general, an Electronic Medical Record (EMR) system is a medical information system that combines a conventional method of managing medical records using paper charts with IT technology and computerizes medical information generated in a hospital. In this EMR system, health state information, such as an individual patient -based medical history, the state of the administration of medicine, examination results, etc., can be easily input and stored, and information can be changed into a form that is convenient to a user.

Meanwhile, since various examinations are conducted together in order to confirm the diagnosis of the illness or disease of a patient or check the state of treatment, a plurality of pieces of patient-based examination information is generated, and the generated examination information is managed in an EMR system.

Various technologies for inquiring about such patient-based examination information in an EMR system are disclosed in Korean Patent Application Publication 10-2005-0008021 (published January 21, 2005), etc. However, since criteria required to filter a massive amount of examination information are not clear in a conventional EMR system, the conventional technologies have problems in that the task of inquiring about examination information takes an excessively long time and a medical staff member must repeat an inconvenient inquiry process in order to obtain desired examination information.

Furthermore, since a plurality of pieces of image information is generated during image examination, a problem arises in that a plurality of images must be checked by the naked eye during an inquiry about examination images. Moreover, since the function of comparing two or more examination images in the same task window is not provided, a medical staff member suffers from great inconvenience during an inquiry about examination images.

### DISCLOSURE

### Technical Problem

Accordingly, the present invention is proposed to overcome the above-described problems of the conventional art, and an object of the present invention is to provide examination information while incorporating specific filtering conditions into a massive amount of examination information.

Another object of the present invention is to form individual filters and a plurality of sub-classification filters, thereby enabling a medical staff member to rapidly access required examination information.

Still another object of the present invention is to classify the sub-classification filters of image filters into filters for anatomical classification, aspect classification, reading room-based classification, etc.

Still another object of the present invention is to arrange individual filters in the form of tabs, thereby facilitating the application of the individual filters.

Still another object of the present invention is to further include a display magnification setting unit and then adjust the display magnification of a task window.

Still another object of the present invention is to arrange and compare two or more pieces of examination information in a single task window.

Still another object of the present invention is to enable basic search conditions and the display format of a task window to be set in advance and changed in accordance with the convenience of a user.

An object of an EMR system-based method of inquiring about examination information according to the present invention is to provide a method of displaying examination information, into which the individual filters and the sub-classification filters have been applied, in accordance with the convenience of a user.

Another object of the present invention is to set basic search conditions and the display format of a task window in advance, thereby providing basic examination information, into which the set basic search conditions and the set display format of a task window have been incorporated, upon an inquiry about examination information.

Still another object of the present invention is to provide examination information retrieved in accordance with a change in filtering conditions.

Still another object of the present invention is to resize a task window and rearrange and provide retrieved examination details in accordance with display magnification when the display magnification is changed.

### TECHNICAL SOLUTION

An electronic medical record (EMR) system-based apparatus for inquiring about examination information according to the present invention includes an examination information inquiry unit configured to inquire about the examination information of a patient from an examination information unit in response to a request for an inquiry about examination information; an examination inquiry control unit configured to control the task of inquiring about the examination information of the patient; and an examination information display unit configured to display the examination information inquired about by the examination information inquiry unit; and an examination inquiry filtering unit configured to incorporate specific filtering conditions into the inquiry when the examination information inquiry unit inquiries about the examination information.

An electronic medical record (EMR) system-based method of inquiring about examination information according to the present invention includes the steps of: (a) requesting an inquiry about the examination information of a patient using an examination inquiry request unit; (b) inquiring about the examination information of the patient using an examination information inquiry unit, and displaying retrieved results on an examination information display unit; and (c) selecting individual filters and sub-classification filters using an examination inquiry filtering unit; wherein step (c) is the step of selecting at least any one individual filter from among a specimen filter configured to filter out specimen-related examination information, a specimen text filter configured to filter out specimen text information, an image filter configured to filter out an examination result image, a function filter configured to filter out function examination results, a pathological filter configured to filter out pathological examination information, and a period filter configured to filter out examination results within a specific period, and then selecting a sub-classification filter that operates in conjunction with the individual filter.

### ADVANTAGEOUS EFFECTS

As described above, the EMR system-based apparatus for inquiring about examination information according to the present invention can filter out specific examination information from a massive amount of examination information while taking into account specific filtering conditions, thereby providing the effect of enabling the examination information inquiry task of a medical staff member to be efficiently performed in an EMR system.

Furthermore, the present invention provides the effect of forming individual filters and a plurality of sub-classification filters, thereby enabling a medical staff member to rapidly access examination information to be inquired about.

Furthermore, the present invention provides the effect of applying a filter specialized for search for an examination image selected from the sub-classification filters of the image filters, thereby considerably improving the efficiency of an inquiry about an examination image.

Furthermore, the present invention provides the effect of arranging individual filters in the form of tabs, thereby facilitating the application of the individual filters individual filter and also facilitating the checking of the sub-classification filters connected to the individual filters.

Furthermore, the present invention provides the effect of adjusting the display magnification of a task window, thereby rearranging examination information in accordance with the display magnification and also arranging and comparing two or more pieces of examination information in a single task window.

Furthermore, the present invention provides the effect of enabling basic search conditions and the display format of a task window to be set in advance and changed in accordance with the convenience of a user, thereby personalizing an examination information inquiry task.

The EMR system-based method of inquiring about examination information according to the present invention provides the effect of provision a method of displaying examination information, into which the individual filters and the sub-classification filters have been applied, in accordance with the convenience of a user.

Furthermore, the present invention provides the effect of setting basic search conditions and the display format of a task window in advance, thereby providing personalized retrieved examination information upon an inquiry about examination information.

Furthermore, the present invention provides the effect of displaying examination information retrieved in accordance with a change in filtering conditions.

Furthermore, the present invention provides the effect of resizing a task window and rearranging and providing retrieved examination details in accordance with display magnification when the display magnification is changed.

### DESCRIPTION OF DRAWINGS

FIG. 1 is a diagram of the overall configuration of an EMR system-based apparatus for inquiring about examination information according to the present invention;

FIG. 2 is a diagram showing the detailed configuration of an examination inquiry filtering unit in an EMR system-based apparatus for inquiring about examination information according to the present invention;

FIGS. 3 to 5 are embodiment screens in which individual filters have been selected in an EMR system-based apparatus for inquiring about examination information according to the present invention;

FIG. 6 is an embodiment screen showing a one-magnification task window in an EMR system-based apparatus for inquiring about examination information according to the present invention;

FIG. 7 is an embodiment screen showing a two-magnification task window in an EMR system-based apparatus for inquiring about examination information according to the present invention;

FIG. 8 is a first embodiment screen showing a three-magnification task window in an EMR system-based apparatus for inquiring about examination information according to the present invention;

FIG. 9 is a second embodiment screen showing a three-magnification task window in an EMR system-based apparatus for inquiring about examination information according to the present invention; and

FIG. 10 is a flowchart showing the overall flow of an EMR system-based method of inquiring about examination information according to the present invention.

### BEST MODE

Specific details that are required to practice an EMR system-based apparatus and method for inquiring about examination information according to the present invention will be described as follows.

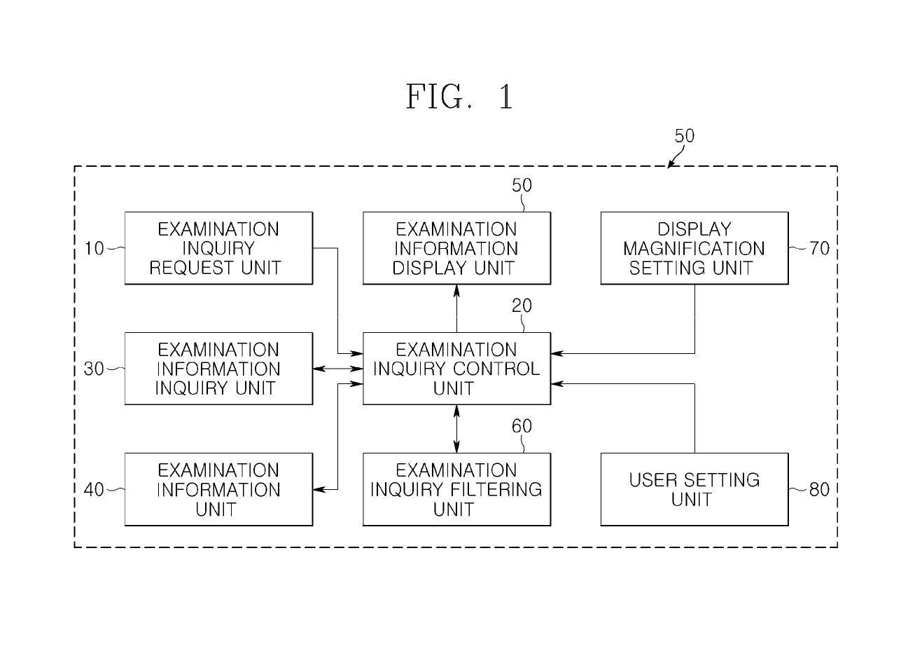

FIG. 1 is a diagram of the overall configuration of an EMR system-based apparatus 100 for inquiring about examination information according to the present invention, which includes an examination inquiry request unit 10, an examination inquiry control unit 20, an examination information inquiry unit 30, an examination information unit 40, an examination information display unit 50, an examination inquiry filtering unit 60, a display magnification setting unit 70, and a user setting unit 80.

The examination inquiry request unit 10 functions to request a patient-based examination information inquiry and to select specific examination information from a retrieved examination information list and request a detailed examination information inquiry. An examination information request signal is transferred to the examination inquiry control unit 20.

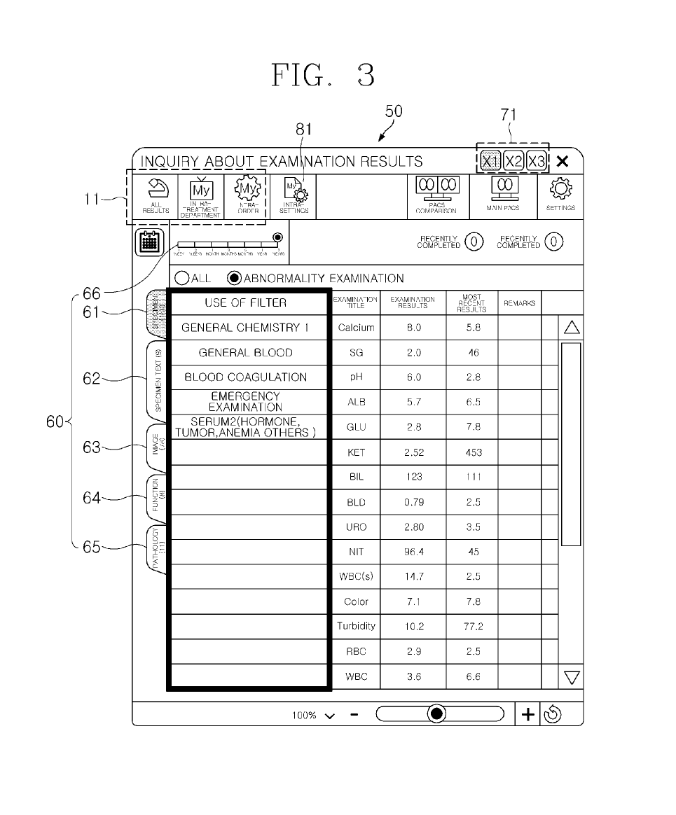

In an embodiment of the present invention, the examination inquiry request unit 10 includes a full result button configured to request an inquiry about patient-based full examination results, an intra-medical department button configured to request an inquiry about the results of an examination conducted by the medical department of a medical staff member who makes the inquiry, and an intra-order button configured to request an inquiry about the results of an examination for which an order has been issued by a medical staff member who makes the inquiry, as shown in FIG. 3.

The examination inquiry control unit 20 functions to control the task of inquiring about the examination information of a patient using the examination information inquiry unit 30 when an examination information inquiry request signal is transferred from the examination inquiry request unit 10, and functions to control the task of arranging and displaying the content of retrieved examination information.

The examination information inquiry unit 30 is connected to the examination inquiry control unit 20, and functions to inquire about the examination information of the patient from the examination information unit 40 in response to the request signal from the examination inquiry request unit 10. The examination information inquiry unit 30 according to the present invention classifies and inquiries about examination information in accordance with the filtering conditions of the examination inquiry filtering unit 60.

The examination information unit 40 is connected to the examination inquiry control unit 20, and functions to store and manage the information of an examination conducted on a patient basis. The examination information unit 40 according to the present invention stores the patient information, an examination name, an examination date, examination results, examination image information, etc. It is preferred that each examination image be stored such that the filtering conditions of the examination inquiry filtering unit 60 can be identified.

The examination information display unit 50 is connected to the examination inquiry control unit 20, and functions to display the examination information inquired about by the examination information inquiry unit 30. The examination information display unit 50 according to the present invention may adjust display magnification to a magnification of 2, 3 or higher based on a one-magnification task window. According to the display magnification, the size of the task window is variable, and accordingly the arrangement format of the examination information is also variable.

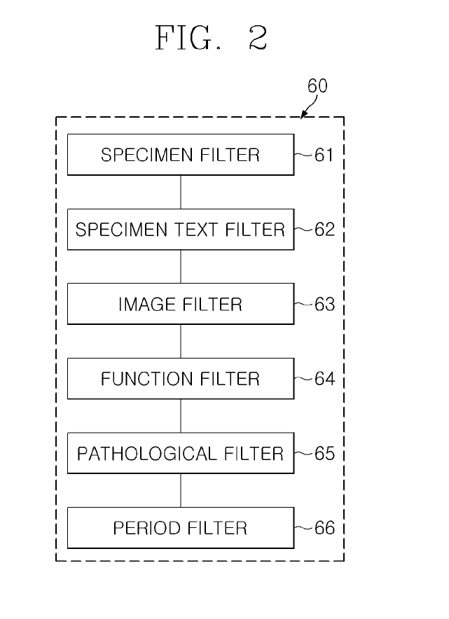

The examination inquiry filtering unit 60 is connected to the examination inquiry control unit 20, and functions to incorporate the filtering conditions into the inquiry about examination information. The examination inquiry filtering unit 60 according to the present invention includes individual filters and sub-classification filters. The individual filters include: a specimen filter 61 configured to filter out specimen-related examination information; a specimen text filter 62 configured to filter out specimen text information; an image filter 63 configured to filter out an examination result image; a function filter 64 configured to filter out function examination results; a pathological filter 65 configured to filter out pathological examination information; and a period filter 66 configured to filter out examination results within a specific period, as shown in FIG. 2. It is preferable to indicate the number of pieces of examination information included in each of the filters.

Furthermore, the individual filters each include at least one sub-classification filter, and performs information search in a tree structure.

FIGS. 3 to 5 are diagrams showing embodiment screens in which the examination inquiry filtering unit 60 according to the present invention has been implemented in the examination information display unit 50. It is preferred that the individual filters of the examination inquiry filtering unit be arranged and displayed in the form of tabs on one side of the task window of the examination information display unit 50.

FIG. 3 is a diagram showing examination information that is filtered out by the specimen filter 61. The specimen filter 61 is implemented to include sub-classification filters, such as filters for general chemistry 1, general blood, blood coagulation, emergency examination, and serum 2.

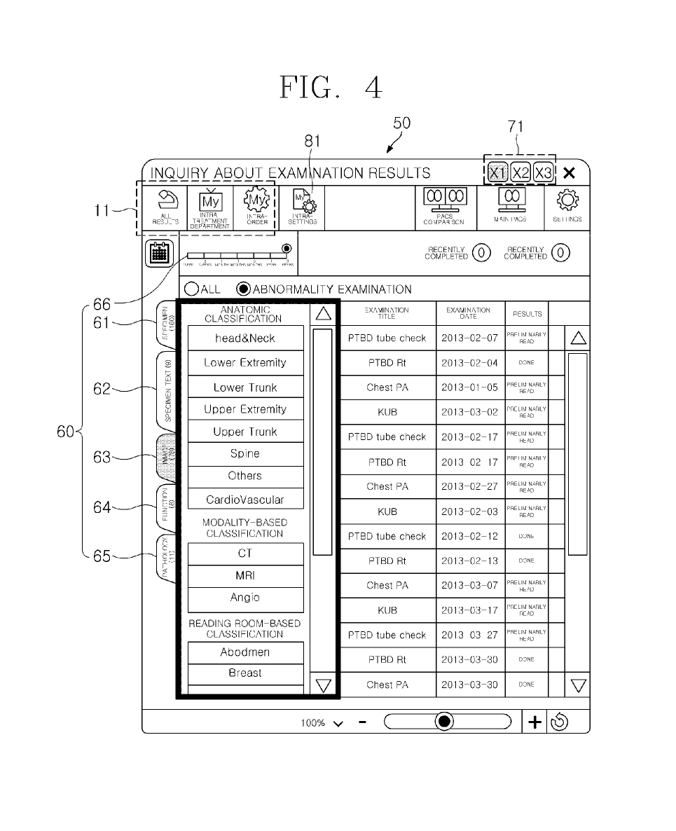

FIG. 4 is a diagram showing examination information that is filtered out by the image filter 63. The image filter 63 according to the present invention is implemented to include sub-classification filters, such as filters for anatomical classification, aspect classification, and reading room-based classification. This enables a medical staff member to rapidly approach a desired examination image among a numerous number of examination images.

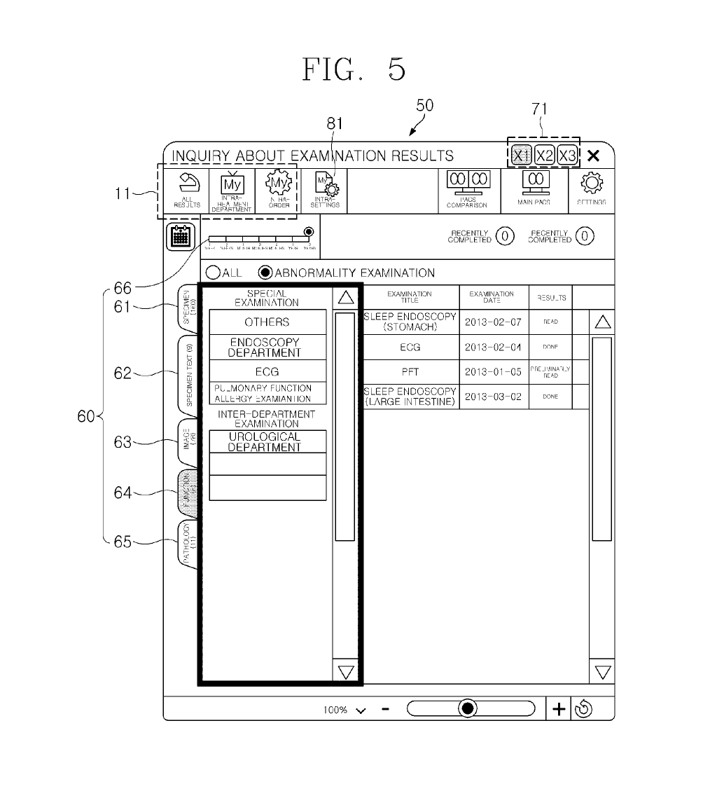

FIG. 5 is a diagram showing examination information that is filtered out by the function filter 64. The function filter 64 according to the present invention is implemented to include sub-classification filters for special examination and intra-department examination.

The display magnification setting unit 70 is connected to the examination inquiry control unit 20, and functions to adjust the display magnification of the task window. In an embodiment of the present invention, the display magnification is set via one-magnification, two-magnification and three-magnification display magnification setting buttons 71 on one side of the upper portion of the examination information display unit 50.

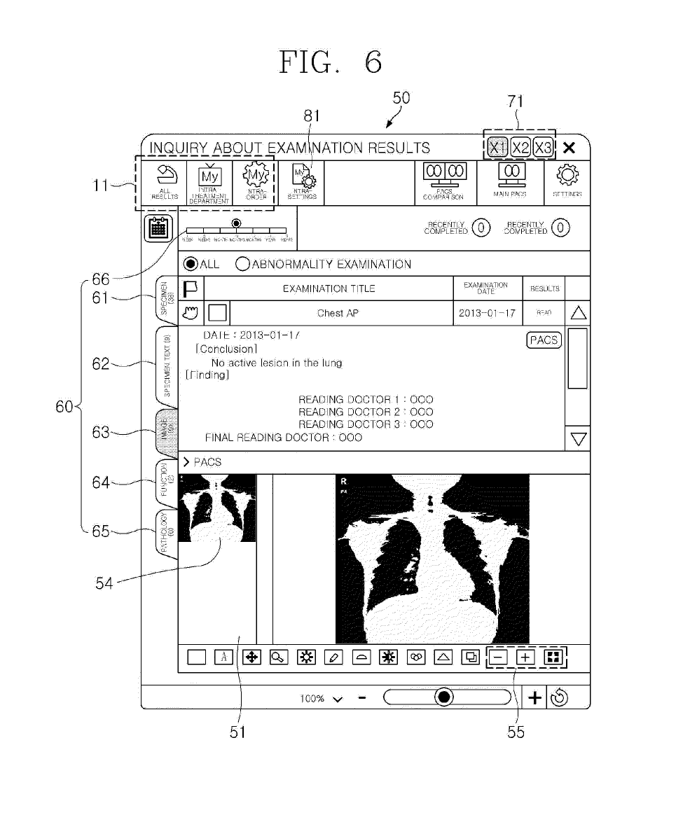

FIG. 6 is an embodiment screen in which the display magnification setting unit 70 is set to a magnification of 1 and examination information inquired about by the image filter 51 is displayed on the one-magnification task window 51 of the examination information display unit 50. On this embodiment screen, an examination name, an examination date, examination results and detailed information are displayed on the upper side, and an examination image is displayed on the lower side. It is preferred that the examination information display unit 50 according to the present invention further display a thumbnail image 54 on one side of selected examination image. It is preferred that the examination information display unit 50 according to the present invention further include an image task tool 55 capable of adjusting the state of the selected examination image.

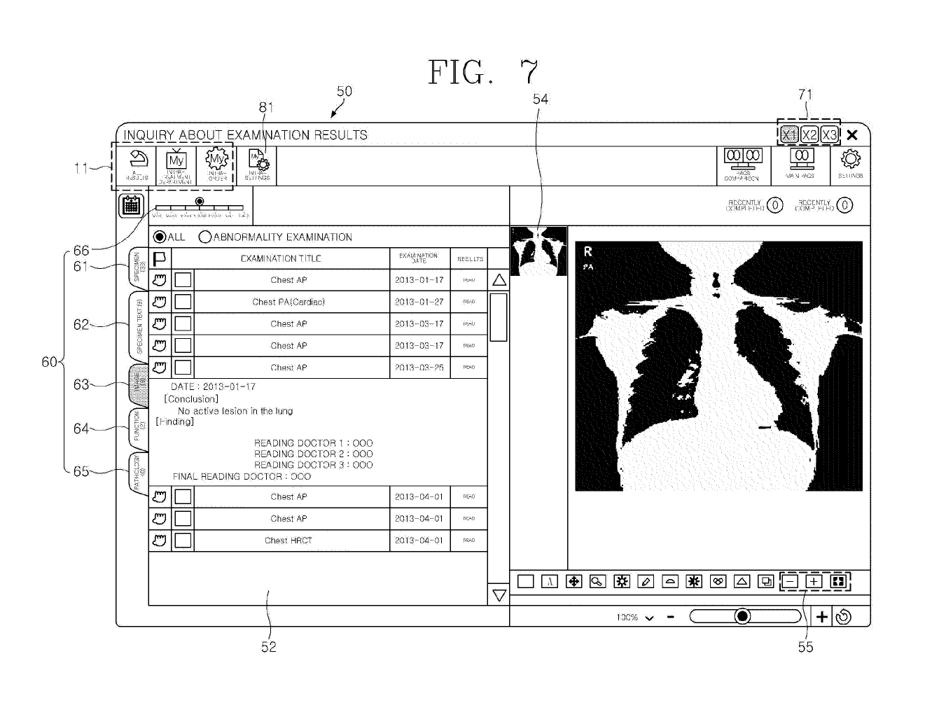

FIG. 7 is an embodiment screen in which the display magnification setting unit 70 according to the present invention is set to a magnification of 2 and examination information inquired about by the image filter 51 is displayed on the two-magnification task window 52 of the examination information display unit 50. On this embodiment screen, image examination information is displayed in the form of a list on the left side so that when a specific image examination is selected, image examination date, examination details, reading information is displayed, and a selected examination image is displayed on the right side.

This two-magnification task window 52 provides the effect of enabling the detailed content of an examination image and an actual examination image to be simultaneously checked in a list in which a plurality of pieces of examination image information is arranged, and the effect of facilitating the checking of an examination image because an image is displayed in a size larger than that of the 1magnification task window 51.

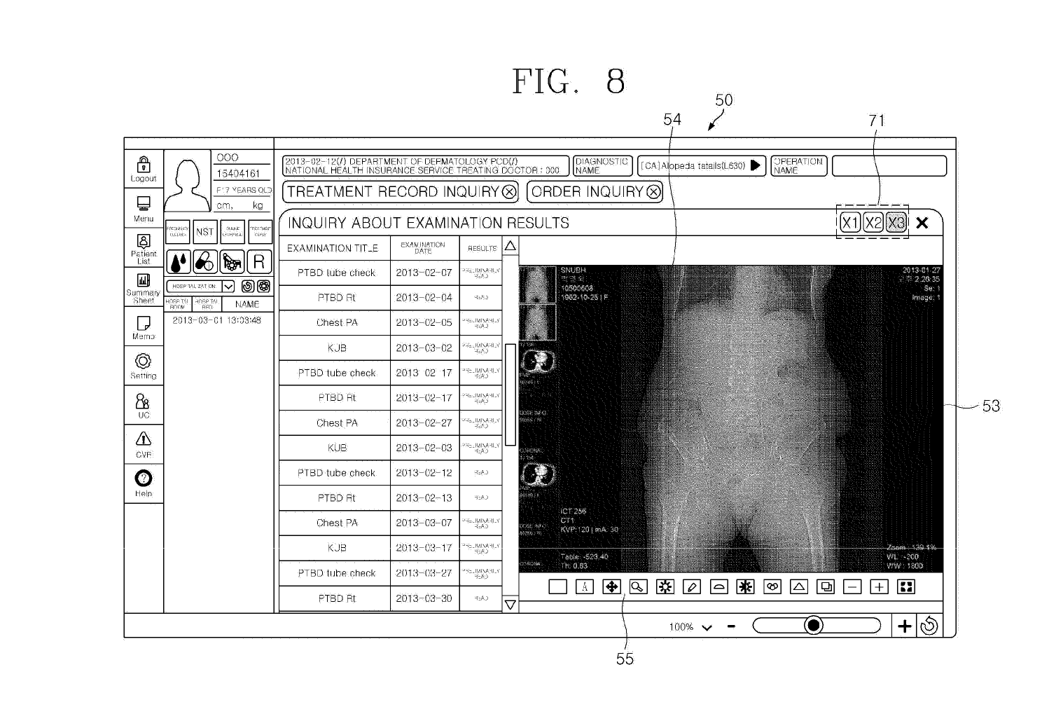

FIG. 8 is an embodiment screen in which the display magnification setting unit 70 according to the present invention is set to a magnification of 3 and examination information inquired about by the image filter 51 is displayed on the three-magnification task window 53 of the examination information display unit 50. On this embodiment screen, image examination information is displayed on the form of a list on the left side, and a selected examination image is displayed in the maximum size on the right side.

In this three-magnification task window 53, a list in a plurality of pieces of examination image information is arranged, an examination image may be previously viewed using a plurality of thumbnail images on the right side, and a selected examination image can be checked in a size larger than the two-magnification task window 52.

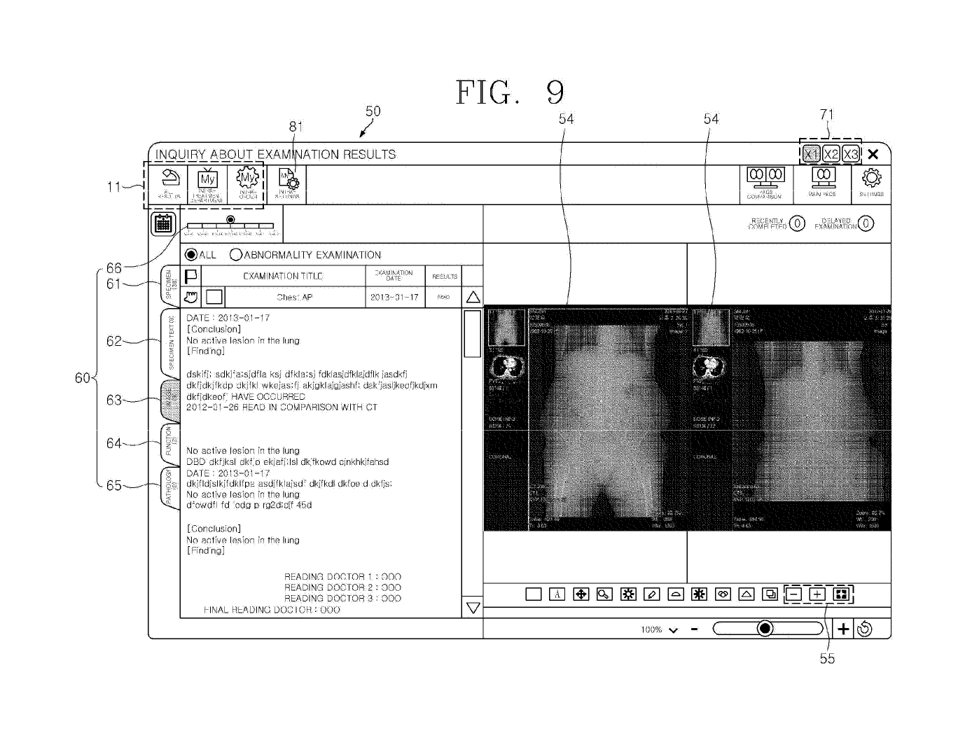

FIG. 9 is an embodiment screen in which the display magnification setting unit 70 according to the present invention is set to a magnification of 3 and examination information inquired about by the image filter 51 is displayed in the three-magnification task window 53 of the examination information display unit 50. On this embodiment screen, a list in which a plurality of pieces of examination image information is arranged on the left side and two examination images are displayed parallel at the center and on the right side so that a plurality of pieces of examination information may be compared within a single task window.

The user setting unit 80 is connected to the examination inquiry control unit 20, and functions to, upon an inquiry about examination information, set basic search conditions and the display format of the examination information display unit. In an embodiment of the present invention, the content of the individual filters and the sub-classification filters and the basic display magnification of the task window are set via the user setting unit 80, thereby enabling an examination information inquiry task to be personalized and thus improving the convenience of a medical staff member.

As described above, when the EMR system-based apparatus for inquiring about examination information according to the present invention is applied, it is possible to filter out specific examination information from a massive amount of examination information while taking into account specific filtering conditions, thereby providing the effect of enabling the examination information inquiry task of a medical staff member to be efficiently performed in an EMR system.

A method of inquiring about examination information using the EMR system-based apparatus for inquiring about examination information according to the present invention is described as follows.

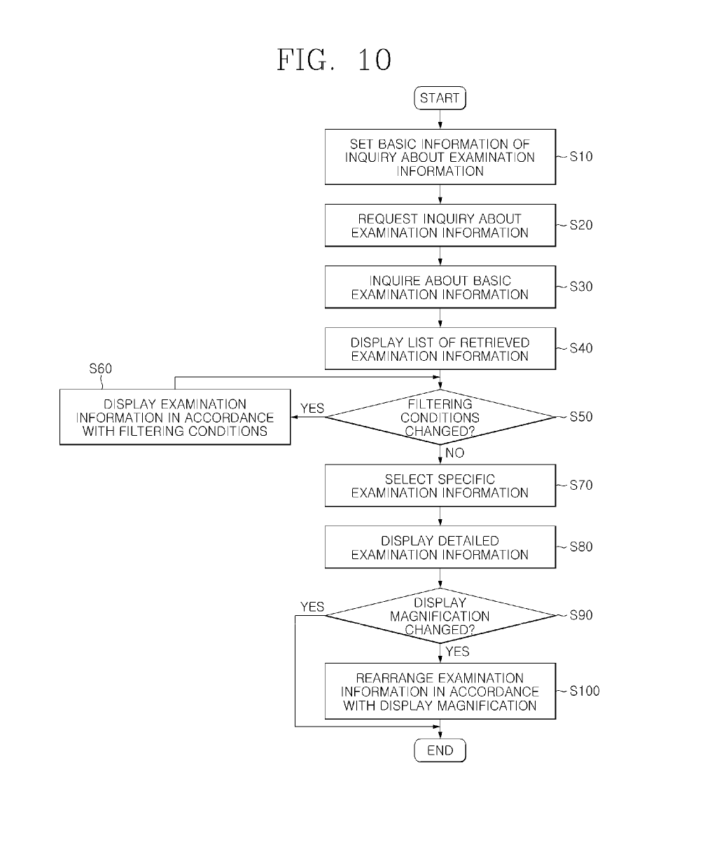

FIG. 10 is a flowchart showing the overall flow of an EMR system-based method of inquiring about examination information according to the present invention. In the EMR system-based method of inquiring about examination information, step S10 of setting basic search conditions and the display format of a task window using the user setting unit 80 is performed. Via step S10 according to the present invention, the content of the individual filters and the sub-classification filters and the basic display magnification of the task window may be set in accordance with the convenience of a medical staff member.

Thereafter, step S20 of requesting an inquiry about the examination information of a patient using the examination inquiry request unit 10 is performed, step S30 of inquiring about the examination information of the patient using the examination information inquiry unit 30 is performed, and step S40 of displaying retrieved results on the examination information display unit is performed.

It is preferred that at step S40 according to the present invention, the task window be displayed at the basic display magnification set at step S10, basic filtering conditions be arranged, and the number of pieces of examination information for each of the individual filters be also displayed.

Thereafter, using the examination inquiry control unit, step S50 of determining whether the filtering conditions have been changed using the examination inquiry filtering unit 60 is performed. If the filtering conditions have been changed, step S60 of displaying examination information in accordance with the selected individual filter and the sub-classification filter is performed, and the process returns to step S50, at which it is determined whether the search conditions have been additionally changed.

If it is determined at step S50 that a change in the filter information has not occurred, step S70 of selecting specific examination information from a displayed examination information list is performed, and step S80 of displaying the detailed content of the selected examination information is performed. It is preferred that when an examination image is selected at step S80, a thumbnail image of the selected examination image be also displayed.

Thereafter, step S90 of determining whether the display magnification of the display magnification setting unit 70 has been changed using the examination inquiry control unit 20. If it is determined at step S90 that the display magnification has been changed and display magnification change information has been input, step S100 of resizing the task window and rearranging and displaying retrieved examination information in accordance with the display magnification.

At step S100, the display magnification is resized to any one of a magnification of 1, a magnification of 2, and a magnification of 3. When the selected display magnification is a magnification of 2 or higher, two or more examination information task windows may be displayed.

As described above, when the EMR system-based method of inquiring about examination information according to the present invention is applied, the EMR system-based method of inquiring about examination information can achieve the effect of providing personalized inquiry examination information upon an inquiry about examination information because basic search conditions and the display format of a task window can be set in advance, and also the effect of resizing a task window in accordance with display magnification and rearranging and providing retrieved examination details because examination information to which the individual filters and the sub-classification filters have been applied can be displayed in accordance with the convenience of a user and display magnification can be changed.

Although the above description has been given by way of the embodiments of the present invention, the technical spirit of the present invention is not limited to the embodiments. The present invention may be implemented as various EMR system-based apparatuses and methods for inquiring about examination information within the range that does not depart from the technical spirit of the present invention.

1. An electronic medical record (EMR) system-based apparatus for inquiring about examination information, comprising:
an examination information inquiry unit configured to inquire about examination information of a patient from an examination information unit in response to a request for an inquiry about examination information;
an examination inquiry control unit configured to control a task of inquiring about the examination information of the patient; and
an examination information display unit configured to display the examination information inquired about by the examination information inquiry unit; and
an examination inquiry filtering unit configured to incorporate specific filtering conditions into the inquiry when the examination information inquiry unit inquiries about the examination information.

2. The EMR system-based apparatus of claim 1, wherein:
the examination inquiry filtering unit comprises at least any one of individual filters, including a specimen filter configured to filter out specimen-related examination information, a specimen text filter configured to filter out specimen text information, an image filter configured to filter out an examination result image, a function filter configured to filter out function examination results, a pathological filter configured to filter out pathological examination information, and a period filter configured to filter out examination results within a specific period; and
the individual filters each comprise at least one sub-classification filter.

3. The EMR system-based apparatus of claim 2, wherein the image filter comprises at least any one of sub-classification filters for anatomical classification, aspect classification, and reading room-based classification.

4. The EMR system-based apparatus of claim 2, wherein the examination information display unit arranges and displays the individual filters of the examination inquiry filtering unit in a tab form on one side of a task window.

5. The EMR system-based apparatus of claim 1, further comprising a display magnification setting unit connected to the examination inquiry control unit and configured to adjust display magnification of a task window.

6. The EMR system-based apparatus of claim 5, wherein when the display magnification setting unit sets a size of the task window to a magnification of 2 or higher, the examination information display unit arranges two or more pieces of examination information.

7. The EMR system-based apparatus of claim 1, further comprising a user setting unit connected to the examination inquiry control unit and configured to set basic search conditions and a display format of the examination information display unit during the inquiry about examination information.

8. An electronic medical record (EMR) system-based method of inquiring about examination information, comprising the steps of:
(a) requesting an inquiry about examination information of a patient using an examination inquiry request unit;
(b) inquiring about the examination information of the patient using an examination information inquiry unit, and displaying retrieved results on an examination information display unit; and
(c) selecting individual filters and sub-classification filters using an examination inquiry filtering unit;
wherein step (c) is the step of selecting at least any one individual filter from among a specimen filter configured to filter out specimen-related examination information, a specimen text filter configured to filter out specimen text information, an image filter configured to filter out an examination result image, a function filter configured to filter out function examination results, a pathological filter configured to filter out pathological examination information, and a period filter configured to filter out examination results within a specific period, and then selecting a sub-classification filter that operates in conjunction with the individual filter.

9. The EMR system-based method of claim 8, further comprising, before step (a), step (d) of setting basic search conditions and a display format of a task window using a user setting unit.

10. The EMR system-based method of claim 8, further comprising, after step (c), step (e) of displaying results of the inquiry about examination information retrieved in accordance with selected filtering conditions using an examination information inquiry unit.

11. The EMR system-based method of claim 10, further comprising, after step (c) or (e):
(f) selecting specific examination information from the retrieved examination information using an examination inquiry request unit; and
(g) displaying detailed content of the selected specific examination information using an examination information display unit.

12. The EMR system-based method of claim 11, further comprising, after step (g):
(h) checking whether display magnification change information has been input to a display magnification setting unit using an examination inquiry control unit, and, if the display magnification change information has been input, resizing a task window in accordance with display magnification and rearranging and displaying the retrieved examination information.

13. The EMR system-based method of claim 12, wherein step (h) is the step of selecting any one of a magnification of 1, a magnification of 2, a magnification of 3 and a magnification of 4 as the display magnification, and then displaying two or more pieces of examination information on the task window when the selected display magnification is a magnification of 2 or higher.
